(19) United States
(12) Patent Application Publication
(10) Pub. No.: US 2012/0039481 A1
(43) Pub. Date: Feb. 16, 2012

(54) HEADPHONES SYSTEM

(76) Inventor: John McClain, Los Angeles, CA (US)

(21) Appl. No.: 13/181,971

(22) Filed: Jul. 13, 2011

Related U.S. Application Data
(60) Provisional application No. 61/364,533, filed on Jul. 15, 2010.

(51) Int. Cl. H04R 1/10

(52) U.S. Cl. 381/74

(57) ABSTRACT

Portable headphones system having a headphones set, a portable media device, and a remote control. The headphones set is adapted to directly mount the portable media device such that a digital audio signal is received directly by a digital audio amplifier of the headphones set. The remote control is adapted to receive song and playlist data from the portable media player and to display this information to the user. The user can issue commands to the portable media player and to the headphones set using the remote control.

### CROSS-REFERENCE TO RELATED APPLICATIONS

The present application claims the benefit under 35 U.S.C. §119(e) of the U.S. Provisional Patent Application Ser. No. 61/364,533 filed Jul. 15, 2010, the content of which is incorporated herein by reference.

### FIELD OF THE INVENTION

The present invention relates generally to a headphones system, and more specifically, to a headphones system with a portable headphone set, a portable audio player device, and a portable wireless remote control device.

### BACKGROUND OF THE INVENTION

In a typical portable headphones system, a user carries around a portable audio player device and a separate, portable headphone set which is connected to the portable audio player by a loose wire. A standard headphone set generally consists of two earpieces (right and left) (also known as “cans”), each enclosing a small audio driver (or speaker). The earpieces may be located partially inside the ear, or outside the ear. In over-the-head type headphone sets, each earpiece is typically mounted to one end of a headband support which usually has an inverted U-shape and which sits on the user's head. Portable audio player devices in such systems may include portable CD players, iPods®, or MPEG Audio Layer III (mp3) players. Each portable audio player device includes a headphone jack into which a standard wire may be plugged to output an audio signal from the device.

Such typical headphone sets include one or more loose wires, either connected to a single side of the headphone set, or directly to both the left and right sides. The loose wire is typically terminated with a standard ⅛″ headphone plug connector for insertion into a complimentary headphone jack of the portable audio device. To output the audio signal from a portable digital audio device, the device converts the digital music (e.g., a track from a CD or an mp3 file) from a digital file to an analog signal. The portable audio device then amplifies the signal for output through the headphone jack. The portable headphone set receives the amplified signal through the headphone jack and emits the music through the earpieces.

There are many problems associated with the standard systems described above. First, the loose wire attached to the headphone set needs to be long enough to accommodate different placement of the portable audio device while being used. Long, loose wires become cumbersome to handle when attempting to use the portable audio device, and may get caught on external objects while the user is moving. Another problem is that the sound quality of the audio file is highly dependent on the quality of the analog-to-digital converter, and the audio amplifier, located inside the portable audio device. As the endeavor is to make portable audio devices as small and as cheap as possible, the quality of the analog-to-digital converter, and the audio amplifier, can degrade with size and price. This causes a less than adequate listening experience for the user. Yet another problem is that, when in use, the user must hold or secure the portable digital audio player device separately from the headphone set. Prior art wireless portable audio systems have attempted to overcome some of the above problems of loose wired portable audio systems by replacing the loose-wired connection between the portable digital audio player and the headphone set with a wireless connection. Such wireless portable audio systems include a point-to-point wireless connection such as via radio frequency (RF) or infra-red (IR). However, while such prior wireless portable audio systems overcome some of the problems of loose-wired systems, they encounter other problems, such as interruptions of the wireless communication signal, due for example to interference from other electrical devices. Such interruptions, even if for short periods of time (for example seconds long or even fractions of seconds) can be unacceptable to a user because with such wireless devices, the entire audio stream is being transmitted wirelessly and even small or short interruptions in an audio signal can be very undesirable for a user. Furthermore, such prior wireless portable audio systems do not overcome the problem found with wire systems in that, during use, the user must secure or store the portable digital audio player on the person's body separately from the headphone set.

What is desired, therefore, is a headphones system having a portable headphone set and a portable digital audio player, which eliminate the need for all loose wires between the headphone set and the digital audio player and avoids the problems associated with prior loose-wired and wireless portable audio systems.

### SUMMARY OF THE INVENTION

An object of the present invention is to provide a headphone system comprising a portable headphones set having a mounting socket; and a portable media player device mounted in the mounting socket, where the mounting creates a direct wired electrical connection between the headphones set and the media player.

The invention and its particular features and advantages will become more apparent from the following detailed description considered with reference to the accompanying drawings.

### BRIEF DESCRIPTION OF THE DRAWINGS

FIG. 1 is a front view of a headphones set of a preferred embodiment.

FIG. 2 is rear view of a headphones set of a preferred embodiment.

FIG. 3 is a front view of a portable media player of a preferred embodiment.

FIG. 4 is a side view of a portable media player of a preferred embodiment.

FIG. 5 is a left side view of a headphones set of a preferred embodiment.

FIG. 6 is a right side view of a headphones set of a preferred embodiment.

FIG. 7 is a front view of a wireless remote control of a preferred embodiment.

FIG. 8 is a side view of a wireless remote control of a preferred embodiment.

### DETAILED DESCRIPTION OF THE INVENTION

The invention is most clearly embodied in a portable headphones system. A portable headphones system constructed according to the invention contains a headphone set, a portable digital audio player, and a portable wireless remote control.

The headphones set is for playing songs from the portable digital audio media player with no loose wires from the player to headphones set. The player is removably mounted/connected to the headphones set. The wireless remote control (with a display) allows control of the player without the need to remove the headphones. The wireless remote control receives and displays song & playlist information from a transceiver in the headphones. The headphones set holds an iPod or other MP3 or digital audio player or portable media player in a pocket/holder on a side of headband. The pocket has an iPod or data port/connector at the bottom. One headphone “can” has controls: Play/Pause, FFD, REV, etc. The wireless remote control (e.g., via Bluetooth) has control buttons and a display for song/playlist information. The system includes a base for recharging batteries in the headphones set, the wireless remote control and the digital audio player (separately or while installed in headphones). The headphones set and wireless receiver both include a transceiver for transmitting & receiving control commands and song/playlist information. The pocket may partially or entirely cover the iPod when installed, e.g., may only cover the controls, but leave the display exposed. The display of the iPod may be a touchscreen having controls such that the user may issue commands to the iPod using the touchscreen. The system may automatically turn off display of iPod display when connected to headphones to conserve battery power. The headphones set includes a compartment for disposable batteries. The headphones set may automatically switch to disposable battery power when integrated rechargeable batteries drop below a minimum level; or manual switch. The headphones set can power iPod if the iPod battery too low to operate.

To use the system, a user can first charge the headphones, remote, and player, then mount/connect player to headphones (or mount and then charge). The headphones set reads the song/playlist information from player and sends information to the remote (or sends on an as needed basis). The user views the remote display and enters commands via the remote. A transceiver of the headphones set receives commands from user via remote. The controller of headphones set passes control commands to the player. The player executes commands (e.g. play). The headphones set receives audio signals from Player via the data port/connector and passes the signals to the amplifier and then to the speakers/audio drivers.

The portable digital audio player can be an iPod®, or any other suitable type of portable digital audio player. Preferably, the digital audio player has a store of digital audio files and other audio information, such as on a hard drive or solid state memory, or another suitable type of store of digital data. The audio player also preferably has an audio signal output port suitable for connection to a loose-wired headphone set and a data port for connection to other devices.

The headphone set is preferably and overhead-type headphone set and includes two earpieces (right and left), each connected to one of two ends of a headband support. Each earpiece encloses a small audio driver (or speaker). The earpieces may be over-the-ear type earpieces set such that each audio driver is located outside of the user's ear, and generally covering the user's ear, or may be partially within the ear. The headphone set can include different padding types to ensure a comfortable fit for the user. In a preferred embodiment, a circular padding, with a hole in the middle, is affixed to each earpiece. The circular padding allows for a comfortable fit over the user's ear, while the hole in the middle allows for sound to penetrate the user's ear canal.

The headband support preferably has an inverted U-shape and is adapted to sit on top of the head of the user to support. The headphone set, and the headband support can be made of plastic, metal, or of any other type of formable material.

The headphone set includes a direct mount for a digital audio player which is configured and adapted to securely support and directly electronically connect to the portable digital audio player. The direct mount provides a direct (preferably digital) connection between the portable digital audio player and the headphone set thereby eliminating the need for a loose-wired or wireless (RF/IR) connection between the headphone set and the digital audio player.

Preferably, the direct mount is located on the outside of one of the (left or right) sides of the headband support above one of the earpieces, but the direct mount can be located in other positions on the headphone set. The direct mount may be of differing sizes and configurations depending on the size and configuration of the digital audio player to be mounted, and the direct mount may be detachable from the remainder of the headband support, and replaceable with one of several other direct mounts provided in various configurations, to accommodate different sizes or types of digital audio players. Alternatively, the entire headband support can be disconnectable from the earpieces and replaceable with one of several other headband supports to accommodate different digital audio players.

Since the direct mount and/or headband support is interchangeable, the user may select the side (i.e., right or left) on which to mount the digital audio player.

The direct mount includes an electrical data port adapted to interface with the complimentary data connector of the digital audio player for conveying audio signals, control signals and other information and power between the headphone set and the digital audio player. The digital audio player is operable to output audio signals out of the device via the data port. The headphone set is operable to receive the audio signals from the audio player via the data port and to play the audio signal on the audio drivers of the headphone set. The data port may be USB, mini USB, micro USB, iPod® dock connection, or any other type of proprietary or non-proprietary electrical data connection. The data port is preferably integrated into and fixed relative to the direct mount and/or headphone set such that the data port partially secures the digital audio player. In one embodiment, the data port may be interchangeable with other provided data ports of different sizes or configurations. The data port may also be temporarily or permanently replaced by a wire with a data port termination on one end, and the other end being terminated inside of the connection piece.

The direct mount and/or another portion of the headband support or headphone set may further contain a releasable securing means to releasably secure the digital audio player to the headphone set. The releasable securing means may be a strap, latch, recess or any other suitable type of releasable securing structure that allows the digital audio player to be received by the direct mount and to connect to the data port while preventing substantial movement or dislodgement of the audio player while the user moves around wearing the headphone set. Preferably, the direct mount is arranged for generally downward insertion (and generally upward removal) of the digital audio player when the headphone set is in an ordinary orientation (i.e., right side up), such as when being worn in a normal manner on the head of a user in an upright, standing position, so that the player device is securely held in the direct mount during use. In addition, the direct mount preferably is operable to maintain a connection to the player device even if the headset is inverted (i.e., upside down) either via friction, catches, detents or other means, to prevent the player device from unintentional dislodgement.

The releasable securing means may partially, or completely cover, the digital audio player such that all, part of the player (e.g., the display and/or controls), or none of the player is visible when the player is received into the direct mount. Optionally, the amount of the player covered may be adjustable by the user, so that the user can choose how much they want visible, or whether the controls of the player need to be directly accessed.

As set forth above, the headphone set contains a headband support, right and left earpieces and audio drivers. The headphone set further contains a microprocessor, a memory, a digital-to-analog converter, a wireless chip, a wireless receiver, a wireless transmitter, and an audio amplifier. The headphone set may further contain other electrical components necessary to operate a digital audio device. The memory is pre-programmed with standard and proprietary software drivers for digital audio players. This negates the need for the user to install any software in the headphone set to operate the digital audio player.

To operate the headphone set, the user need only insert the digital audio player on to the direct mount such that the data connector of the player engages the data port of the headphone set, and then activate the headphone set. The activation of the headphone set will turn on the digital audio player, although there may be separate power switches for both the headphone set and the player. On the initial insertion of the digital audio player, the system may load the corresponding software driver for the current player. However, all subsequent insertions of the same model player will not require this as the driver will be preloaded.

Once the headphone set is activated, the user can control all standard functions using the native (i.e., built-in) controls located on the digital audio player. The headphone set may further contain separate controls (such as playback controls) on the headband support, or on one or both of the earpieces, or elsewhere on the headphone set. In a preferred embodiment, the playback controls are on the side opposite of the headphone set relative to the side where the digital audio player is mounted. The controls may contain, but are not limited to, play, stop, pause, fast forward, rewind, next track, previous track, volume up, volume down, and mute. In some embodiments, some controls may perform multiple functions. For example, the fast forward button may fast forward if held continuously, but may skip to the next track if pressed without continuously holding the button. The controls may also contain a hold button, or switch, as to not allow the controls to be accidentally accessed.

In a preferred embodiment, the headphone set may contain a battery holder in one or both of the earpieces, or in the headband support, or elsewhere in the headphone set. The holder may be for standard AAA or AA batteries, or may be of a proprietary rechargeable battery. The headphone set may contain a power port for connection to a power plug for recharging the rechargeable battery, such as in the headband support, one or both of the earpieces, or elsewhere on the headphone set. The headphone system may include a docking station adapted for use with the headphone set and the headphone set may contain multiple electrical contacts such that the user need only place the headphone set onto the docking station to recharge the batteries. The docking station can preferably recharge the headphone set, the digital audio player, and the portable wireless remote (discussed below) simultaneously. Or, the digital audio player may be charged separately from the headphone set by the docking system. The digital audio player may also be charged while being attached/mounted to the headphone set.

In one embodiment, the batteries in the headphone set are used to power the headphone set and the digital audio player is separately powered by its own internal battery. In some embodiments, the batteries from the headphone set may also be used to power the attached digital audio player also. The display of the digital audio player may be deactivated when the player device is mounted to the headphone set to conserve the battery life of the player. In some embodiments, the headphone set may contain a second battery holder for additional batteries, in case the rechargeable battery dies, and the user is not able to access an electrical outlet to recharge the batteries. To run on the reserve battery power, the headphone set may automatically switch to the backup batteries, or the user may manually switch over to the backup batteries by activating a switch on the headphone system.

In a preferred embodiment, the headphones system includes a portable wireless remote control device. The portable remote control can be of any shape and size, and can be designed as a stylish addition to the headphone system. The portable wireless remote control may be a small device containing only the playback controls for the digital audio player. The controls may contain, but are not limited to, play, stop, pause, fast forward, rewind, next track, previous track, volume up, volume down, and mute. In some embodiments, some controls may perform multiple functions. For example, the fast forward button may fast forward if held continuously, but may skip to the next track if pressed without continuously holding the button. The controls may also contain a hold button, or switch, as to not allow the controls to be accidentally accessed. The battery may contain a user replaceable, non-rechargeable, battery, a user replaceable, rechargeable battery, or a permanently installed rechargeable battery.

To communicate with the headphone set, the wireless remote control contains a wireless chip, similar to the chip housed inside of the headphone set. The wireless remote is set up with a direct connection to the wireless headphones. The wireless connection may be Bluetooth, WLAN, or any other type of piconet, point-to-point, or spread spectrum wireless connection, or may be an IR connection. The remote control may be pre-programmed to connect to a particular headphone set with which the remote is provided, or the remote control may be an add-on requiring the user to manually pair the two devices together.

In one embodiment, to control the headphone set, the wireless remote control sends one-way control signals to the headphone set, activating pre-programmed functions, such as next track, fast forward, or pause. The headphone set receives the control signals and relays the same or corresponding control signals to the digital audio player via the data port for execution by the player device.

In another embodiment, the wireless remote control may contain a display and may be operable for two-way (i.e., bi-directional) communication with the headphone set. The display may be operable to display various information about songs stored on the digital audio device and available for playing via the headphone set and may be operable to display information regarding a currently playing song (track) including, but not limited to, artist, album, song length, track number, playlist location, song lyrics, and album art. As above, the wireless remote control may send control signals to the headphone set for controlling the digital audio player and/or the headphone set. However, in one embodiment, the headphone set also sends audio information to the remote control for display on the remote control. The remote control receives the audio information and stores and/or displays the information on the display. In an alternative embodiment, the controls and display of the wireless remote control may be integrated into a touch screen.

To enable a user to select a particular audio file (i.e., song) or playlist available on the digital audio player, the information received by the wireless remote from the headphone set preferably includes audio file identification information or playlist identification information, which is transmitted back to the headphone set (and relayed to the digital audio player) when a particular song or playlist is selected by the user via the remote control. Alternatively, or additionally, an audio file selection menu (user interface) of the digital audio can be duplicated on the wireless remote and synchronized with digital audio player such that selection commands entered on the remote control by the user (such as scrolling to a particular song or playlist and then selecting the song or playlist) can be duplicated and executed on the digital audio player in real-time (i.e., simultaneously) without the need to transmit song or playlist identification information between the headphone set and the wireless remote control.

The audio information received by the portable, wireless remote control may be cached in a memory located inside the wireless remote. If the information is pre-cached, every time the wireless remote and the headphone set is powered on, the information from the headphone set is compared to the information stored in the wireless remote, and the information is updated as necessary. In some embodiments, the information is not pre-cached in the wireless remote, and the information is transferred from the headphone set to the wireless remote as required, such as upon each track change. As with the one-way remote above, the two-way wireless remote may duplicate all or substantially all of the controls located on the digital audio player or on the headphone set. The two-way remote control is the primary controller for the digital audio player and may act as a wireless display and controller of the headphone set.

The invention may be more clearly understood from a description of the drawings, which illustrate various embodiments of the invention.

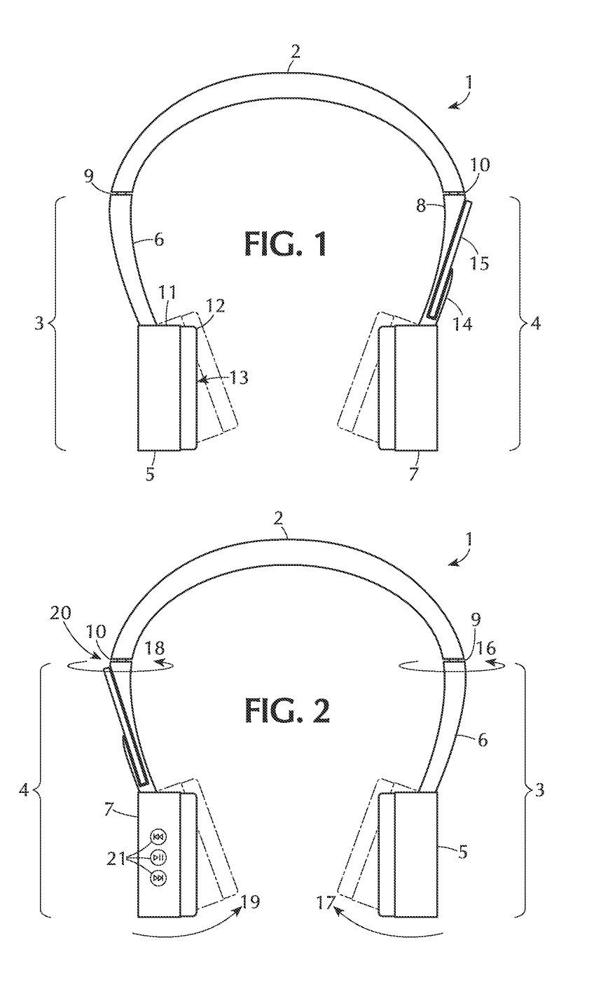

FIG. 1 illustrates a front view of a preferred embodiment of a portable headphones system, showing headphones set 1. Headphones set 1 comprises a headband support 2, left earpiece 3, and right earpiece 4. Headband support 2 is adapted to sit on top of the head of a user, and can be made of plastic, metal, or any other suitable formable material. In alternate embodiments, headband support 2 can comprise padding in order to provide a comfortable and secure fit. In alternate embodiments, headband support 2 can be adjusted to fit various head sizes.

Left earpiece 3 comprises left speaker assembly 5 and left speaker attachment 6. Right earpiece 4 similarly comprises right speaker assembly 7 and right speaker attachment 8.

Left earpiece 3 is removably attached to headband support 2 via connection 9, made between headband support 2 and left speaker attachment 6. Right earpiece 4 is attached to headband support 2 in a like fashion via connection 10

Left speaker assembly 5 comprises enclosure 11, padding 12, and encloses an audio driver (speaker) 13. In a preferred embodiment, padding 12 is circular, with a hole in the middle, and affixed to enclosure 11 in such a way as to provide a comfortable fit for the user, to encapsulate the user's ear such that outside noise is excluded, and to orient left speaker assembly 5 to allow sound from the audio driver 13 to enter the user's ear canal. Right speaker assembly 7 is comprised similarly to left speaker assembly 5.

In a preferred embodiment, right speaker attachment 8 further comprises a direct mount 14 for an audio player 15. Direct mount 14 is disposed on or within right speaker attachment 8 and is configured and adapted to removably attach, securely support and directly electronically connect to audio player 15. Direct mount 14 is of a size and configuration adapted to the size and configuration of the audio player 15, and may be detachable from headphones set 1 and interchangeable with alternate direct mounts.

In alternate embodiments, direct mount 14 can be disposed on or within different parts of headphones system 1, such as left earpiece 3, or headband support 2, for example.

FIG. 2 illustrates a rear view of a preferred embodiment of headphones set 1. Here, connection 9 is shown adapted to permit left earpiece 3 to pivot either partially or completely about a vertical axis as illustrated by reference arrow 16, and to permit left earpiece 3 to be removed from headband support 2. Left speaker assembly 5 is shown attached to left speaker attachment 6 in such a way as to permit left speaker assembly 5 to pivot about a horizontal axis as illustrated by reference arrow 17. Connection 10 is shown attached and comprised in an identical fashion to Connection 9, and right speaker assembly 7 is shown attached and comprised in an identical fashion to left speaker assembly 5, permitting similar pivots, orientations, supports, and sound described with respect to left speaker assembly 5, as indicated by reference arrows 18 and 19.

Direct mount 14 is preferably arranged such that when audio player 15 is mounted, right earpiece 4 remains free to rotate about its vertical axis as described above without interference. Direct mount 14 is also preferably arranged for a generally downward insertion of audio player 15 with respect to the pictured orientation of headphones set 1, as shown by reference arrow 20.

In a preferred embodiment, headphones set 1 comprises controls 21 which may be standard audio transport controls (e.g. buttons for play, pause, fast-forward, rewind/review, etc.) and/or power, volume, or other controls related to the operation of the system as further described herein. In a preferred embodiment, controls 21 are disposed on right speaker assembly 7. In alternate embodiments, controls 21 can be disposed elsewhere on headphones set 1.

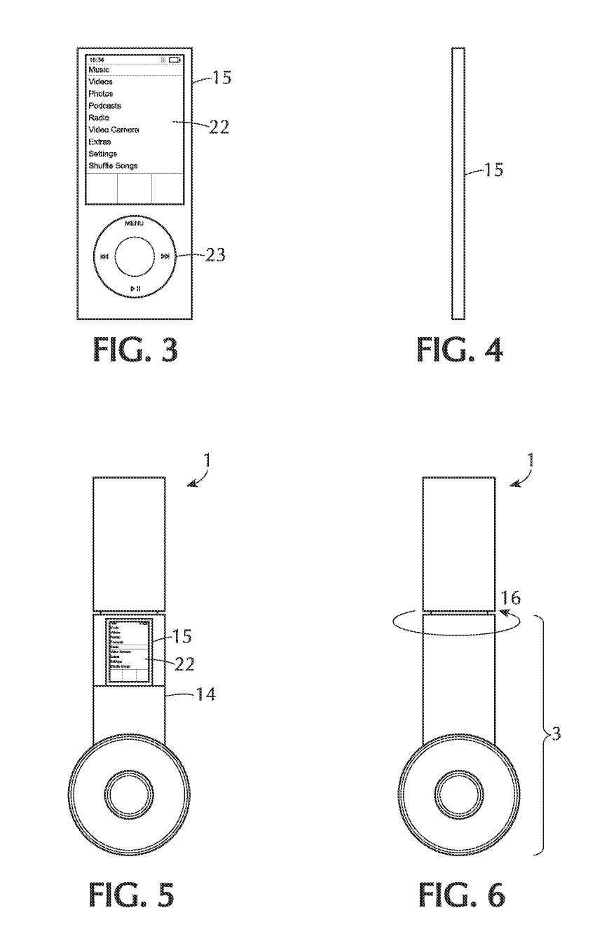

FIG. 3 illustrates a front view of audio player 15. Audio player 15 may comprise an audio player display 22 and audio player controls 23. Audio player 15 may be any suitable audio player, such as a portable digital audio player as further described herein. FIG. 4 illustrates a side view of audio player 15, which may be of a slim profile that facilitates convenient integration with headphones set 1 (not shown).

FIG. 5 illustrates a right side view of a preferred embodiment of headphones set 1. Here, audio player 15 is shown removably mounted in direct mount 14 such that audio player display 22 is visible, while the audio player's controls 23 (not shown) are covered by direct mount 14. In alternate embodiments, audio player display 22 can be covered and/or audio player controls 23 (not shown) can be visible and/or accessible. FIG. 6 illustrates a left side view of a preferred embodiment of headphones set 1, further illustrating the vertical axis pivotability of left earpiece 3, as shown by reference arrow 16.

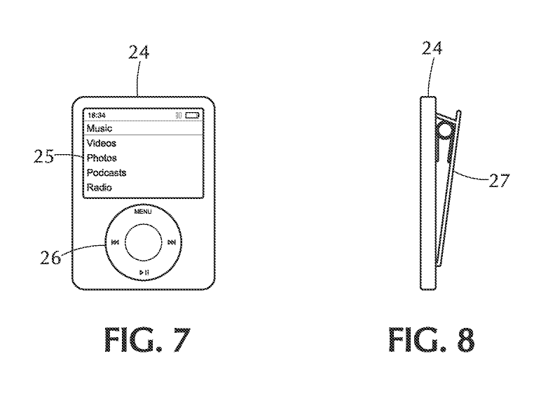

FIG. 7 illustrates a preferred embodiment of a remote control 24 of the headphones set 1 (not shown). Remote control 24 may comprise remote display 25 and/or controls 26. Controls 26 may be standard audio transport controls (e.g. play, pause, fast-forward, rewind/review, etc.) and/or power, volume, or other controls related to the operation of the system as further described herein.

FIG. 8 illustrates a side view of remote control 24, which may be of a slim profile and may comprise retaining clip 27, which may for example be used to attach remote control 24 to the user's clothing or effects.

It would be appreciated by those skilled in the art that various changes and modifications can be made to the illustrated embodiment without departing from the spirit of the present invention. All such modifications and changes are intended to be covered hereby.

What is claimed is:

1. A headphone system comprising: a portable headphones set having a mounting socket; and a portable media player device mounted in the mounting socket, where the mounting creates a direct wired electrical connection between the headphones set and the media player.

2. The headphone system of claim 1, where: the direct wired electrical connection comprises a direct connection between a connector within the mounting socket and a data port on the media player.

3. The headphone system of claim 2, where: the direct wired electrical connection facilitates the transmission of one or more digital audio signals, and the headphones set comprises a digital audio amplifier adapted to receive the digital audio signals and amplify them for reproduction by the headphones set.

4. The headphone system of claim 3 where: the direct wired electrical connection facilitates the transmission of command signals.

5. The headphone system of claim 4 where: the direct wired electrical connection facilitates powering the media player and charging a media player battery by the headphones set.

6. The headphone system of claim 5 where: the headphones set powers the media player and charges the media player battery only when a low charge condition is detected in the media player battery.

7. The headphone system of claim 1, further comprising: a wireless remote control.

8. The headphone system of claim 7, where the wireless remote control comprises controls and is adapted to issue commands to the media player when the controls are activated.

9. The headphone system of claim 8, where the controls of the wireless remote are used to issue audio transport commands.

10. The headphone system of claim 9, where the wireless remote control comprises a display.

11. The headphone system of claim 10, where the headphones set and the wireless remote control are each adapted to facilitate the communication of song and playlist information from the media player to the wireless remote control.

12. The headphones system of claim 11, where the wireless remote control is operable to display song and playlist data.

13. The headphones system of claim 7, where the headphones set and the wireless remote control each comprise a wireless transceiver adapted to facilitate wireless communications among the headphones set, the wireless remote control, and the media player.

14. The headphones set of claim 1, where the mounting socket is removable and swappable with alternative mounting sockets.

15. The headphones set of claim 1, where the headphones set comprises audio transport controls.

16. The headphones set of claim 7, further comprising a charging system having a headset battery disposed internal to the headphones set that is rechargeable, and a headset charging dock adapted to allow the headset battery to be charged by connecting the headphones set to the headset charging dock.

17. The headphones set of claim 16, where the charging system comprises a remote control battery disposed internal to the remote control that is rechargeable and a remote control charging dock adapted to allow the remote control battery to be charged by connecting the remote control to the remote control charging dock and where the remote control charging dock is integral with the headset charging dock, is integral with the headphones set, or is a standalone unit.

18. A method of operating a headphone system comprising the steps of:
providing a portable headphones set;
providing a portable media player device;
providing a mounting means on the portable headphones set;
mounting the portable media player device in the mounting means on the portable headphones set,
the mounting means adapted to receive the portable media player device such that a direct wired electrical connection is created between the headphones set and the media player;
transmitting a digital audio signal from the portable media player to the headphones set via the direct wired electrical connection; and,
amplifying the digital audio signal for reproduction by the portable headphones set.

19. The method of claim 18, further comprising the steps of:
providing a wireless remote control having a display and controls;
transmitting song and playlist data from the portable media device to the remote control;
displaying the song and playlist data on the display of the remote control device; and,
transmitting a command from the remote control to either the portable media player or the headphones set when the controls of the remote control are activated.

20. The method of claim 19, further comprising the steps of charging the portable media player device via the mounting means; charging the remote control via a remote control charging means; and, charging the headphones set via a headphones set charging means.
